(19) United States
(12) Patent Application Publication
(10) Pub. No.: US 2017/0374277 A1
(43) Pub. Date: Dec. 28, 2017

(54) IMAGE PICKUP APPARATUS, IMAGE PICKUP METHOD, AND RECORDING MEDIUM FOR IMAGING PLURAL SUBJECTS OR A SINGLE SUBJECT

(71) Applicant: CASIO COMPUTER CO., LTD., Tokyo (JP)

(72) Inventors: Koki DOBASHI, Tokyo (JP); Tsutomu TERAZAKI, Saitama-shi (JP); Hiroyuki KATO, Tokyo (JP)

(73) Assignee: CASIO COMPUTER CO., LTD., Tokyo (JP)

(21) Appl. No.: 15/431,104

(22) Filed: Feb. 13, 2017

(30) Foreign Application Priority Data
Jun. 23, 2016 (JP) 2016-124913

(51) Int. Cl. H04N 5/232; H04N 5/235; G05D 1/00; G05D 1/12; B64C 39/02; B64D 47/08; H04N 7/18; G06K 9/00

(52) U.S. Cl. CPC H04N 5/23219; H04N 7/183; H04N 5/2351; H04N 5/23296; G06K 9/0063; G05D 1/12; B64C 39/024; B64D 47/08; G05D 1/0094; B64C 2201/042; B64C 2201/024; B64C 2201/127

(57) ABSTRACT

An image pickup apparatus having a controlling unit, a propulsion unit for propulsion of the image pickup apparatus, and an image pickup unit which images plural subjects or a single subject. The controlling unit controls the propulsion unit to move the image pickup apparatus such that at least two out of the plural subjects and the image pickup unit do not interfere in position with each other, or such that the single subject and the image pickup unit do not interfere in position with each other. For instance, detecting a line of the plural subjects, the controlling unit controls the propulsion unit to move the image pickup apparatus to a position in a direction perpendicular to a longitudinal direction of the detected line of the plural subjects, and instructs the image pickup unit to image the plural subjects or the single subject.

### CROSS-REFERENCE TO RELATED APPLICATION

The present application is based upon and claims the benefit of priority from the prior Japanese Patent Application No. 2016-124913, filed Jun. 23, 2016, the entire contents of which are incorporated herein by reference.

### BACKGROUND OF THE INVENTION

### 1. Field of the Invention

The present invention relates to a technique of imaging plural subjects or a single subject.

### 2. Description of the Related Art

In recent, flight devices or so-called drone-type flying devices are widely used in various fields, which are provided with four propulsion units using rotor blades driven by electric motors. Particularly, the drone-type flying device with a digital camera fixed on is used for performing an imaging operation at an unreachable high place which is very dangerous for a human to perform operation. The drone-type flying devices having the digital camera have come into wide use by making use of a timer function of the digital camera and a remote control operation.

When the drone-type flying device is used to image a subject, an operator of the drone-type flying device is required to control the drone-type flying device to move the digital camera fixed to the drone-type flying device to a position appropriate for imaging the subject.

A conventional technique for solving the above inconvenience is disclosed in Japanese Unexamined Patent Publication No. 2004-118087, which technique uses a photo balloon controlled by a signal sent from a cellular phone. Receiving from the cellular phone a signal of requesting for performing an imaging operation, the photo-balloon moves in the air toward an area including a position indicated by position data contained in the received signal, and operates its image pickup unit to image the subject, when it is determined that the photo-balloon has reached the area.

### SUMMARY OF THE INVENTION

According to one aspect of the invention, there is provided an image pickup apparatus which comprises a propulsion unit which is used for propulsion of the image pickup apparatus, an image pickup unit which images plural subjects or a single subject, and a controlling unit which controls the propulsion unit to move the image pickup apparatus such that at least two out of the plural subjects and the image pickup unit do not interfere in position with each other, or such that the single subject and the image pickup unit do not interfere in position with each other, and instructs the image pickup unit to image the plural subjects or the single subject.

According to another aspect of the invention, there is provided an image pickup method in an image pickup apparatus, the image pickup apparatus being provided with a controlling unit, a propulsion unit, and an image pickup unit for imaging plural subjects or a single subject, the image pickup method comprising steps of making the controlling unit control the propulsion unit to move the image pickup apparatus such that at least two out of the plural subjects and the image pickup unit do not interfere in position with each other, or such that the single subject and the image pickup unit do not interfere in position with each other, and making the controlling unit instruct the image pickup unit to image the plural subjects or the single subject.

According to still other aspect of the invention, there is provided a non-transitory computer-readable recording medium with a computer program stored thereon, the computer program prepared for making a computer control an image pickup apparatus, wherein the image pickup apparatus is provided with a propulsion unit for propulsion of the image pickup apparatus and an image pickup unit for imaging plural subjects or a single subject, and the computer program, when installed on the computer, making the computer control the propulsion unit to move the image pickup apparatus such that at least two out of the plural subjects and the image pickup unit do not interfere in position with each other, or such that the single subject and the image pickup unit do not interfere in position with each other, and making the computer instruct the image pickup unit to image the plural subjects or the single subject.

Additional objects and advantages of the invention will be set forth in the following description, and in part will be obvious from the description, or may be learned by practice of the invention. The objects and advantages of the invention may be realized and obtained by means of the instrumentalities and combinations particularly pointed out hereinafter.

### BRIEF DESCRIPTION OF SEVERAL VIEWS OF THE DRAWING

The accompanying drawings, which are incorporated in and constitute a part of the specification, illustrate embodiments of the inventions, and together with the general description given above and the detailed description of the embodiments given below, serve to explain the principles of the invention.

FIG. 1 is a view showing an example of an appearance of a flight apparatus commonly used in embodiments of the invention, which apparatus operates as an image pickup apparatus of a flight type.

FIG. 2 is a view showing an example of a system configuration of the flight apparatus having the structure shown in FIG. 1.

FIG. 3 is a view for explaining a first embodiment of the invention.

FIG. 4 is a flow chart of an image pickup operation controlling process performed by the flight apparatus according to the first embodiment of the invention.

FIG. 5 is a view for explaining a second embodiment of the invention.

FIG. 6 is a flow chart of the image pickup operation controlling process performed by the flight apparatus according to the second embodiment of the invention.

FIG. 7 is a view for explaining a third embodiment of the invention.

FIG. 8 is a flow chart of the image pickup operation controlling process performed by the flight apparatus according to the third embodiment of the invention.

FIG. 9 is a view for explaining a fourth embodiment of the invention.

FIG. 10 is a flow chart of the image pickup operation controlling process performed by the flight apparatus according to the fourth embodiment of the invention.

FIG. 11 is a flow chart of the imaging controlling operation process performed by the flight apparatus according to a fifth embodiment of the invention.

FIG. 12 is a flow chart of the imaging controlling operation process performed by the flight apparatus according to a sixth embodiment of the invention.

### DETAILED DESCRIPTION OF THE PREFERRED EMBODIMENTS

The embodiments of the present invention are described with reference to the accompanying drawings in detail. An image pickup apparatus according to the embodiments of the invention is provided with a propulsion unit, an image pickup unit, and a controlling unit. The propulsion unit serves to propel the image pickup apparatus in the air. The image pickup unit serves to image plural subjects or a single subject. The image pickup apparatus according to the embodiments of the invention is a so-called flight apparatus of a drone-type. The controlling unit controls the propulsion unit to move the flight apparatus such that at least two out of the plural subjects and the image pickup unit do not interfere in position with each other, or such that the single subject and the image pickup unit do not interfere in position with each other, thereby allowing the image pickup unit to image the plural subjects or the single subject.

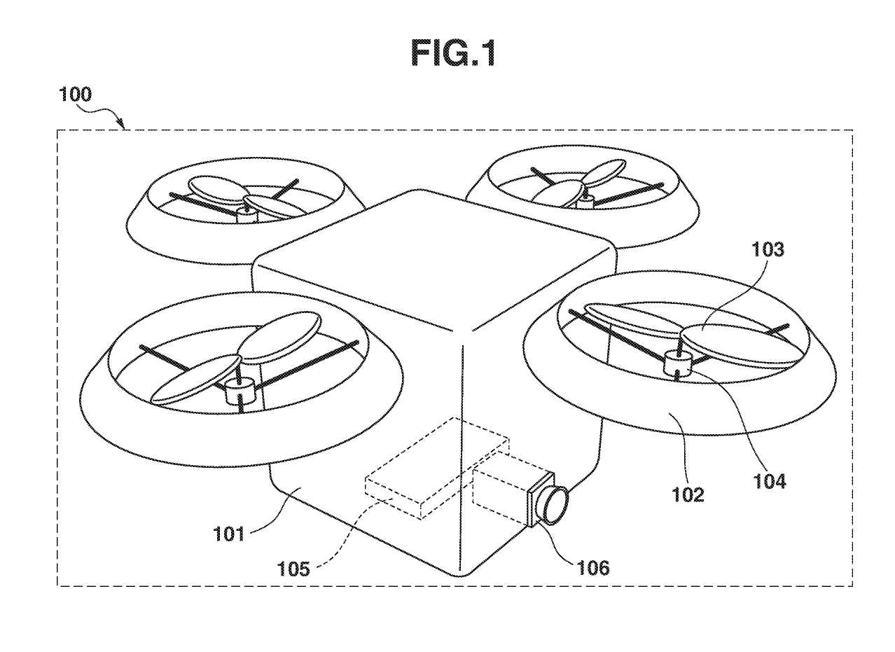

FIG. 1 is a perspective view showing an example of the appearance of the flight apparatus 100, which are commonly used in the respective embodiment of the invention. The flight apparatus 100 operates as the image pickup apparatus of a flight type.

As shown in FIG. 1, the main frame 101 of the flight apparatus 100 is equipped with four circular motor frames (support units) 102. The motor frame 102 supports a motor 104. The motor shaft of the motor 104 has a rotor blade 103 firmly fixed thereon. Four sets of the motors 104 and rotor blades 103 compose a propulsion unit.

The main frame 101 contains a circuit box 105. The circuit box 105 stores a motor driver for driving the motors 104, a controller, and sensors. A camera (an image pickup unit) 106 is installed on a lower part of the main frame 101.

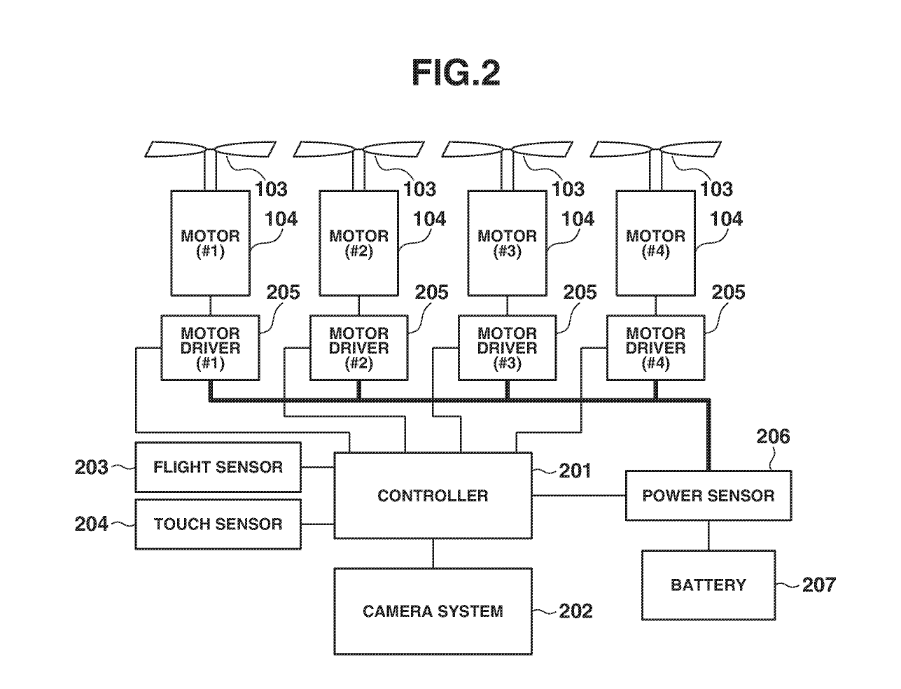

FIG. 2 is a view showing an example of a system configuration of the flight apparatus 100 having the structure shown in FIG. 1. The flight apparatus 100 is commonly used in the embodiments of the invention described below.

As shown in FIG. 2, a controller 201 is connected with a camera system 202, a flight sensor 203, a touch sensor (a contact sensing unit) 204, motor drivers (#1 to #4) 205, and a power sensor 206. The camera system 202 includes the camera 106 (Refer to FIG. 1). The flight sensor 203, for instance, consists of a geomagnetic sensor, an acceleration sensor, a gyro sensor, and a GPS sensor (a Global Positioning Sensor). The motor drivers (#1 to #4) 205 drive the motors (#1 to #4) 104 (Refer to FIG. 1), respectively.

The power sensor 206 supplies the motor drivers 205 with power while monitoring a voltage of a battery 207. A push button which can sense contact may be used in place of the touch sensor 204. Although not shown in FIG. 2, the power of the battery 207 is supplied to a control unit of each of the units 201 to 206, too.

The controller 201 receives information representing a posture of the body of the flight apparatus 100 from the flight sensor 203 in real time. Further, the controller 201 sends each of the motor drivers (#1 to #4) 205 a pulse-wide modulated power-instruction signal based on a duty ratio, while monitoring the voltage of the battery 207 through the power sensor 206. Receiving the power-instruction signals, the motor drivers (#1 to #4) 205 control rotational speeds of the motors (#1 to #4) 104, respectively.

The controller 201 controls the camera system 202 to adjust an image pickup operation of the camera 106 (Refer to FIG. 1).

The controller 201, the camera system 202, the flight sensor 203, the motor drivers (#1 to #4) 205, the power sensor 206 and the battery 207 shown in FIG. 2 are stored in the circuit box 105 of the main frame 101 shown in FIG. 1. Although not clearly shown in FIG. 1, the touch sensor 204 is attached on the main frame 101 in FIG. 1 and/or on the motor frame 102 to detect a difference between an electric physical quantity generated while an operator (a user) touches the frame(s) 101 and/or 102 and an electric physical quantity generated while the operator (the user) does not touch the frame(s) 101 and/or 102.

### First Embodiment of the Invention

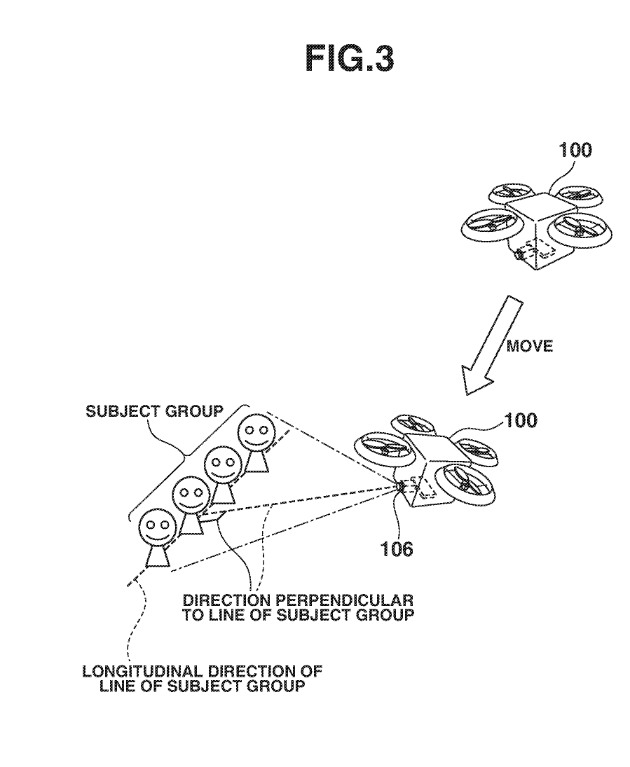

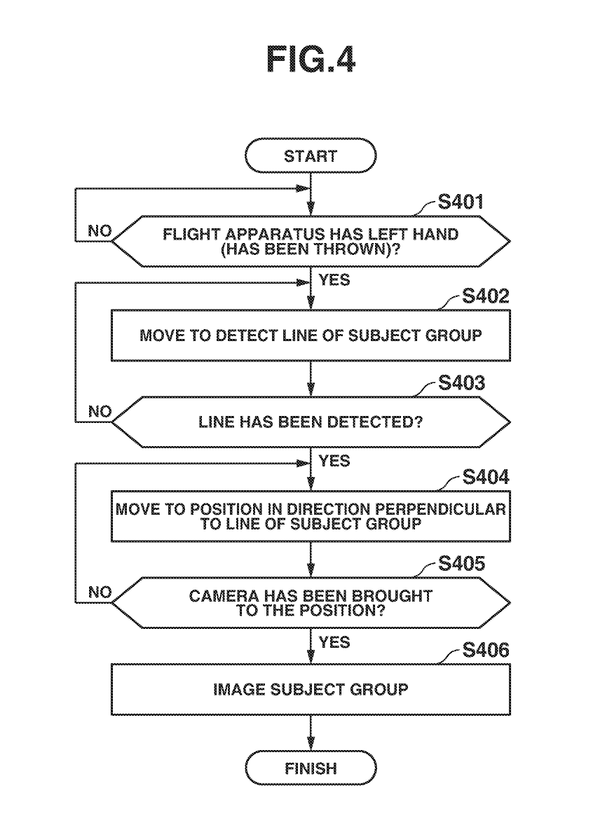

The operation of the flight apparatus 100 having the configuration shown in FIG. 2 is described hereinafter. FIG. 3 is a view for explaining a first embodiment of the invention, in which the flying light apparatus 100 and a subject group including the plural subjects are illustrated. FIG. 4 is a flow chart of an image pickup operation controlling process performed by the flight apparatus 100 according to the first embodiment of the invention. The image pickup operation controlling process is realized by a CPU (a Central Processing Unit) built in the controller 201 of FIG. 2, when a control program stored in a memory (not shown) built in the controller 201 is executed by the CPU.

As shown in FIG. 3, in the first embodiment of the invention, the controller 201 of the flight apparatus 100 detects a line of the plural subjects belonging to the subject group by means of the camera 102 and the camera system 202 and confirms a longitudinal direction of the line of the subjects. Further, the controller 201 moves the flight apparatus 100 in the air to a position in the direction perpendicular to the detected longitudinal direction of the line of the plural subjects, and then instructs the camera 102 and the camera system 202 to perform the image pickup operation at the current position.

The operation of the controller 201 in the first embodiment of the invention is specifically described with reference to the flow chart in FIG. 4.

The controller 201 watches a voltage variation of the touch sensor 204 to repeatedly judge whether the flight apparatus 100 has left a hand of the user or whether the flight apparatus 100 has been thrown by the user (step S401 in FIG. 4).

When it is determined that the flight apparatus 100 has left the hand of the user or the flight apparatus 100 has been thrown by the user (YES at step S401), the controller 201 controls the motor drivers (#1 to #4) 205 to drive the motors (#1 to #4) 104 and rotor blades 103, thereby making the flight apparatus 100 fly through the air to detect the line of the subject group as shown in FIG. 3 (step S402).

More specifically, the controller 201, for example, performs a face recognition process on image data obtained by the camera 102 and the camera system 202 to recognize the faces of the plural subjects. Then, the controller 201 confirms a state in which these recognized faces forma line, thereby detecting the line of the subject group. Further, once having confirmed a state in which the line of the subject group remains still, the controller 201, for example, repeatedly performs the face recognition process on the image data to continuously capture the faces of the plural subjects.

When the flight apparatus 100 flies through the air to detect the line of the subject group (step S402), the controller 201 judges whether the line of the subject group has satisfactorily been detected (step S403).

When it is determined that the line of the subject group has not been detected (NO at step S403), the controller 201 returns to the process of step S402 and tries to detect the line of the subject group, again.

When it is determined that the line of the subject group has been detected (YES at step S403), the controller 201 performs an image processing on the image data obtained by the camera 102 and the camera system 202, whereby controlling the motor drivers (#1 to #4) 205 to drive the motors (#1 to #4) 104 and rotor blades 103 to make the flight apparatus 100 fly through the air to the position in the direction perpendicular to the longitudinal direction of the line of the subject group, as shown in FIG. 3 such that the camera 102 is allowed to image the front faces of the subject group therefrom (a flight controlling process, step S404).

After performing the flight controlling process at step S404, the controller 201 judges whether the camera 102 has been brought to the position in the direction perpendicular to the longitudinal direction of the line of the subject group (step S405).

When it is determined that the camera 102 has not been brought to the position (NO at step S405), the controller 201 returns to the process of step S404, and tries to perform the flight controlling process, again.

When it is determined that the camera 102 has been brought to the position (YES at step S405), the controller 201 controls the camera system 202 to instruct the camera 102 to image the subject group at the position (step S406). At this time, in accordance with a result of the face recognition process performed on the subjects by the controller 201, the camera system 202 performs an auto focusing control operation and an auto exposure controlling operation of the camera 102. And then the controller 201 finishes the image pickup operation controlling process in the first embodiment of the invention.

With availability of an autonomous control of the flight apparatus 100 based on the operation of the controller 201 in the first embodiment described above, simply throwing the flight apparatus 100 in the air, the user can make the camera 102 of the flight apparatus 100 image the plural subjects belonging to the line of the subject group from a front and appropriate position of the subject group in an extremely simple manner.

### Second Embodiment of the Invention

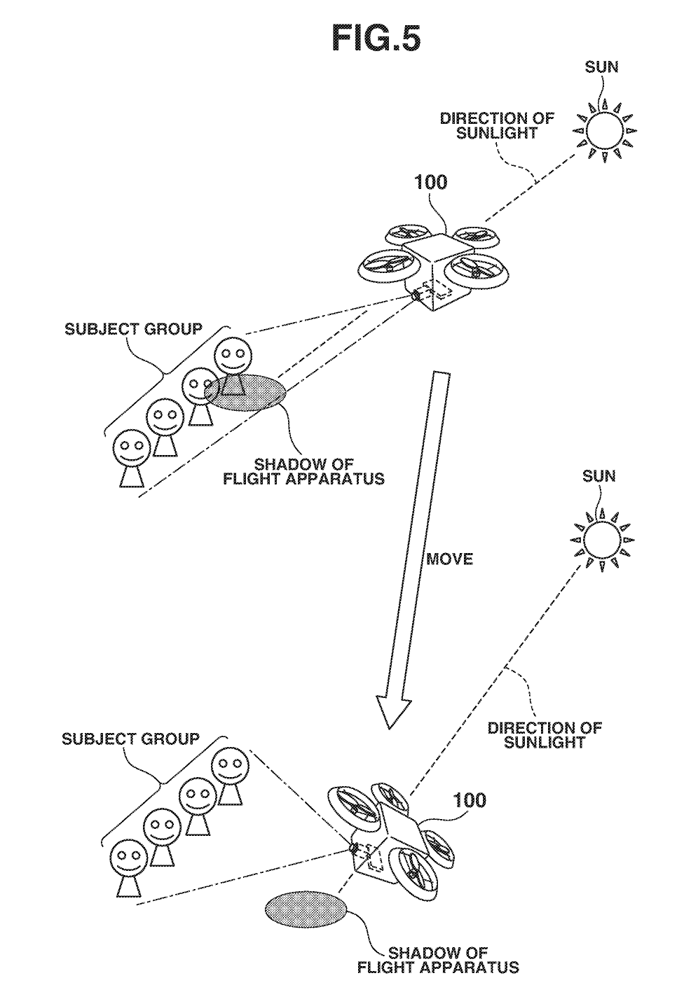

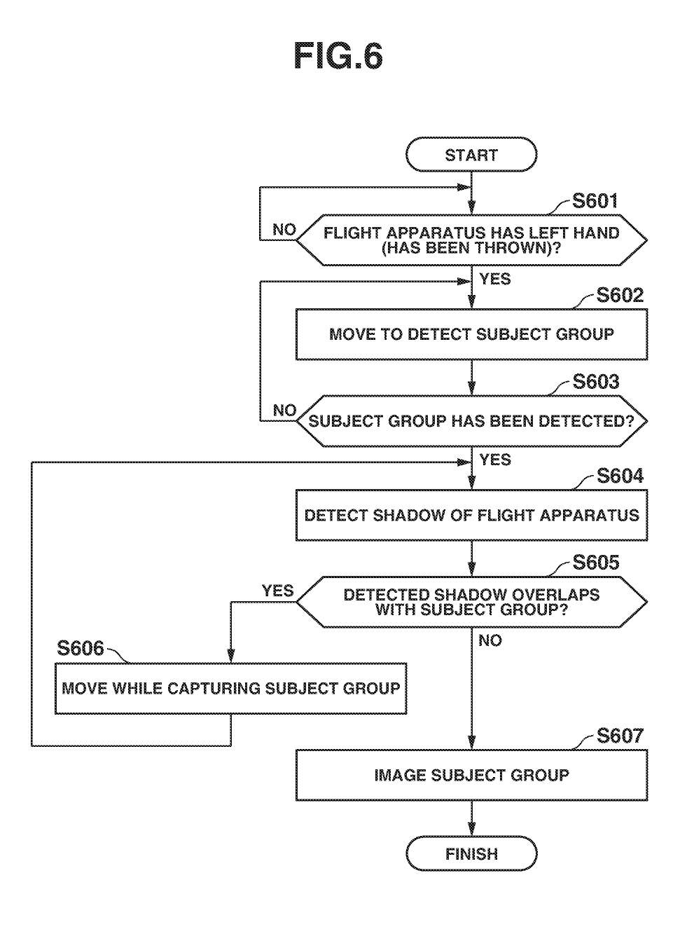

FIG. 5 is a view for explaining a second embodiment of the invention, in which the sun, the flying light apparatus 100 and a subject group including plural subjects are illustrated. FIG. 6 is a flow chart of the image pickup operation controlling process performed by the flight apparatus 100 according to the second embodiment of the invention. Similarly to the process of FIG. 4 in the first embodiment, the image pickup operation controlling process is realized by the built-in CPU of the controller 201 of FIG. 2, when the control program stored in the memory (not shown) built in the controller 201 is executed by the CPU.

As shown in FIG. 5, in the second embodiment of the invention, the controller 201 of the flight apparatus 100 moves the flight apparatus 100 to a position, at which a shadow of the flight apparatus 100 does not overlap with at least one subject belonging to the plural subjects or a single subject, and instructs the camera 102 and the camera system 202 to perform the image pickup operation at the position.

The operation of the controller 201 in the second embodiment of the invention is specifically described with reference to the flow chart of FIG. 6.

The controller 201 repeatedly judges whether the flight apparatus 100 has left the hand of the user or whether the flight apparatus has been thrown by the user (step S601 in FIG. 6), similarly to the process at step S401 in FIG. 4 in the first embodiment of the invention.

When it is determined that the flight apparatus 100 has left the hand of the user or the flight apparatus 100 has been thrown by the user (YES at step S601), the controller 201 controls the motor drivers (#1 to #4) 205 to drive the motors (#1 to #4) 104 and rotor blades 103, thereby making the flight apparatus 100 fly through the air to detect the plural subjects or the single subject as shown in FIG. 5 (step S602).

More specifically, the controller 201, for example, performs the face recognition process on image data obtained by the camera 102 and the camera system 202 to recognize the faces of the plural subjects or the face of the single subject. Then, the controller 201 detects the plural subjects or the single subject. Further, similarly to the first embodiment, once having confirmed a state in which the plural subjects or the single subject remains still, the controller 201, for example, repeatedly performs the face recognition process on the image data to continuously capture the faces of the plural subjects or the face of the single subject.

When the flight apparatus 100 flies through the air to detect the plural subjects or the single subject (step S602), the controller 201 judges whether the plural subjects or the single subject has been detected satisfactorily (step S603).

When it is determined that the plural subjects or the single subject has not been detected (NO at step S603), the controller 201 returns to the process of step S602 and tries to detect the plural subjects or the single subject, again.

When it is determined that the plural subjects or the single subject has been detected (YES at step S603), the controller 201, for example, estimates an azimuth of the sun based on information output from the geomagnetic sensor of the flight sensor 203. Further, the controller 201 performs the image processing on information of the azimuth of the sun and the image data obtained by the camera 102 and the camera system 202 to detect the shadow of the flight apparatus 100 (step S604).

The controller 201 judges whether the detected shadow of the flight apparatus 100 overlaps with the plural subjects or the single subject detected at steps S602 and S603 (step S605).

When it is determined that the shadow of the flight apparatus 100 overlaps with the plural subjects or the single subject (YES at step S605), then the controller 201, while keeping capturing the plural subjects or the single subject, controls the motor drivers (#1 to #4) 205 to drive the motors (#1 to #4) 104 and rotor blades 103, thereby making the flight apparatus 100 fly through the air, for example, for a fixed distance in a random direction (step S606).

Thereafter, the controller 201 returns to the process of step S604, and detects the shadow of the flight apparatus 100, again and judges whether the detected shadow of the flight apparatus 100 overlaps with the plural subjects or the single subject. The controller 201 repeatedly performs these operations.

When it is determined that the detected shadow of the flight apparatus 100 does not overlap with the plural subjects or the single subject (NO at step S605), similarly to the process at step S406 of FIG. 4 in the first embodiment of the invention, the controller 201 instructs the camera system 202 to make the camera 102 image the plural subjects or the single subject from the current position (step S407). Then, the controller 201 finishes the image pickup operation controlling process in the second embodiment of the invention.

With availability of the autonomous control of the flight apparatus 100 based on the operation of the controller 201 in the second embodiment described above, simply throwing the flight apparatus 100 in the air, the user can make the camera 102 of the flight apparatus 100 image the plural subjects belonging to the subject group or the single subject in a simple manner, while avoiding an influence of the shadow of the flight apparatus 100.

A modification may be made to the disclosed second embodiment, in which the controller 201 of the flight apparatus 100 moves the flight apparatus 100 to a position, at which the shadow of the flight apparatus 100 does not overlap with at least one subject belonging to the plural subjects or the single subject and a back light imaging is not allowed, and then makes the camera 102 and the camera system 202 perform the image pickup operation at the position.

### Third Embodiment of the Invention

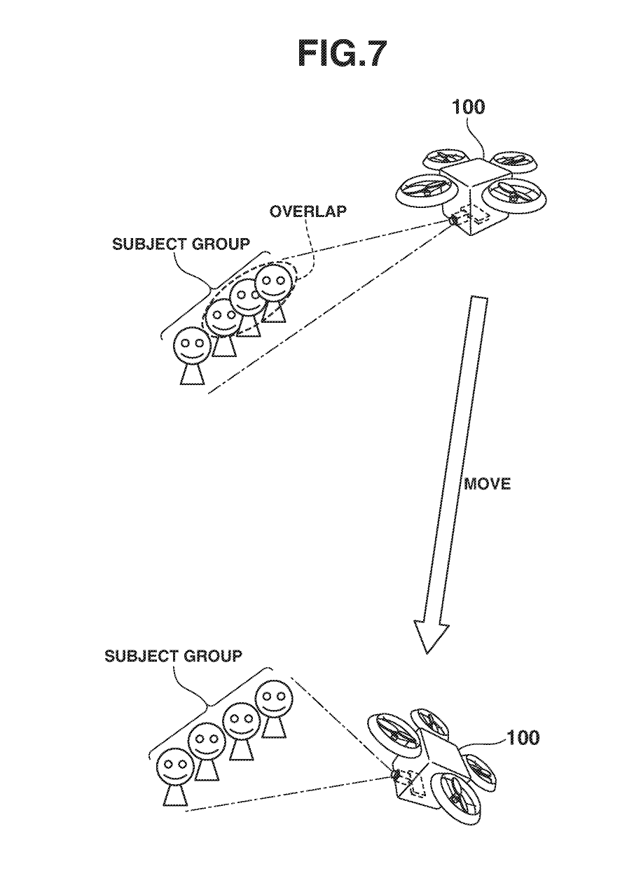

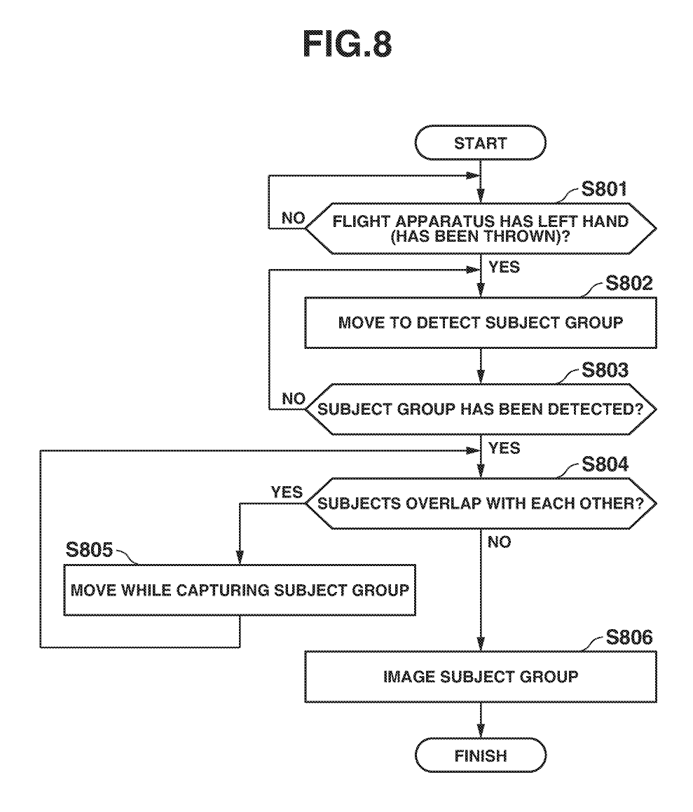

FIG. 7 is a view for explaining a third embodiment of the invention, in which the flying flight apparatus 100 and a subject group including plural subjects are illustrated. FIG. 8 is a flow chart of the image pickup operation controlling process performed by the flight apparatus 100 according to the third embodiment of the invention. Similarly to the process of FIG. 4 in the first embodiment, the image pickup operation controlling process is realized by the built-in CPU of the controller 201 of FIG. 2, when the control program stored in the memory (not shown) built in the controller 201 is executed by the CPU.

In the third embodiment of the invention, the controller 201 of the flight apparatus 100 moves the flight apparatus 100 to a position, at which another subject of the plural subjects does not overlap with a face of at lest one of the plural subjects, as shown in FIG. 7, and makes the camera 102 and the camera system 202 perform the image pickup operation at the position.

The operation of the controller 201 in the third embodiment of the invention is specifically described with reference to the flow chart of FIG. 8. The controller 201 repeatedly judges whether the flight apparatus 100 has left the hand of the user or whether the flight apparatus has been thrown by the user (step S801 in FIG. 8), similarly to the process at step S401 of FIG. 4 in the first embodiment of the invention.

When it is determined that the flight apparatus 100 has left the hand of the user or the flight apparatus 100 has been thrown by the user (YES at step S801), the controller 201 controls the motor drivers (#1 to #4) 205 to drive the motors (#1 to #4) 104 and rotor blades 103, thereby making the flight apparatus 100 fly through the air to detect the subject group as shown in FIG. 7 (step S802).

More specifically, similarly to the process at step S602 of FIG. 6 in the second embodiment, the controller 201, for example, performs the face recognition process on the image data obtained by the camera 102 and the camera system 202 to recognize the faces of the plural subjects. Then, the controller 201 detects the subject group. Further, similarly to the first embodiment of the invention, once having confirmed a state in which the subject group remains still, the controller 201, for example, repeatedly performs the face recognition process on the image data to continuously capture the faces of the plural subjects.

When the flight apparatus 100 flies through the air to detect the subject group (step S802), the controller 201 judges whether the subject group has been detected satisfactorily (step S803).

When it is determined that the subject group has not been detected (NO at step S803), the controller 201 returns to the process of step S802 and tries to detect the subject group, again.

When it is determined that the subject group has been detected (YES at step S803), the controller 201, for example, detects an outline of the face of the subject recognized in the face recognition process which has been performed at step S802 on the image data obtained by the camera 102 and the camera system 202. Then, the controller 201 judges whether any subject whose outline of the face is deficient is included in the subject group, thereby determining whether plural subjects in the subject group overlap each other (step S804).

When it is determined that the plural subjects in the subject group overlap each other (YES at step S804), similarly to the process at step S606 in FIG. 6 in the second embodiment, while keeping capturing the subject group, the controller 201 controls the motor drivers (#1 to #4) 205 to drive the motors (#1 to #4) 104 and rotor blades 103, thereby making the flight apparatus 100 fly through the air, for example, for a fixed distance in a random direction (step S805).

Thereafter, the controller 201 returns to the process of step S804, and judges whether the plural subjects in the subject group overlap each other, again.

When it is determined that the plural subjects in the subject group do not overlap each other (NO at step S804), similarly to the process at step S406 of FIG. 4 in the first embodiment of the invention, the controller 201 instructs the camera system 202 to make the camera 102 image the subject group from the current position (step S806). Then, the controller finishes the image pickup operation controlling process in the third embodiment of the invention.

With availability of the autonomous control of the flight apparatus 100 based on the operation of the controller 201 in the third embodiment of the invention described above, simply throwing the flight apparatus 100 in the air, the user can make the camera 102 of the flight apparatus 100 image the plural subjects belonging to the line of the subject group without any faces of the plural subjects overlapping each other.

### Fourth Embodiment of the Invention

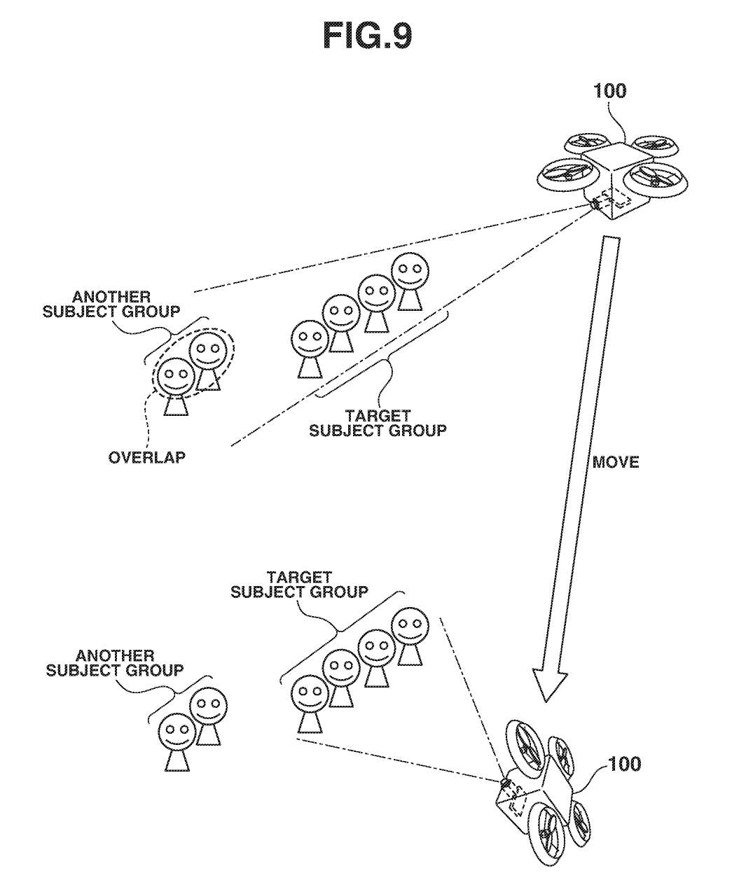

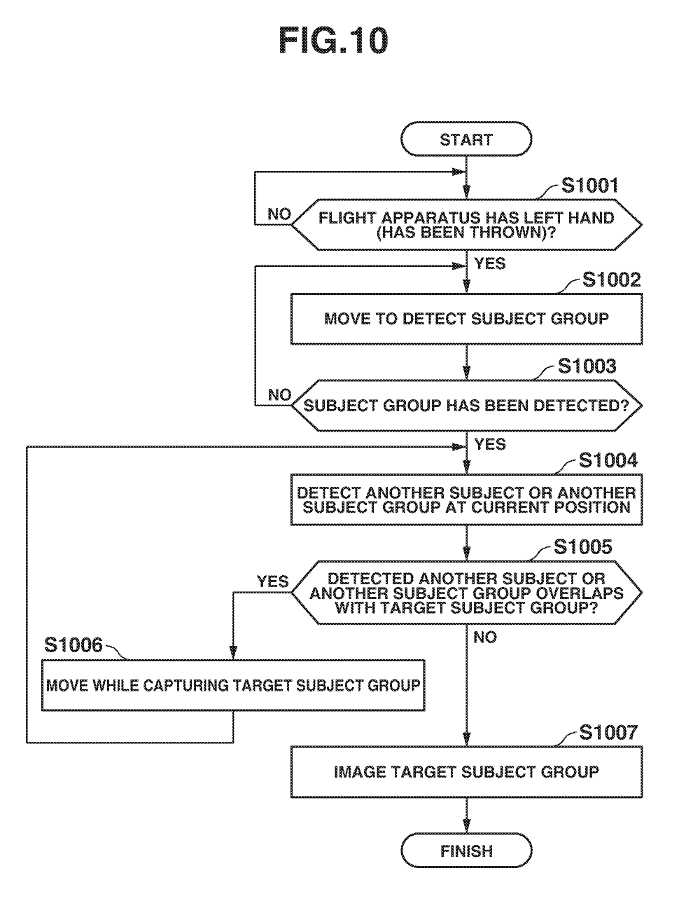

FIG. 9 is a view for explaining a fourth embodiment of the invention, in which the flying flight apparatus 100 and a target subject group and another subject group are illustrated, both groups including plural subjects. FIG. 10 is a flow chart of the image pickup operation controlling process performed by the flight apparatus 100 according to the fourth embodiment of the invention. Similarly to the process in FIG. 4 in the first embodiment, the image pickup operation controlling process is realized by the built-in CPU of the controller 201 in FIG. 2, when the control program is executed by the CPU, stored in the memory (not shown) built in the controller 201.

In the fourth embodiment of the invention, the controller 201 of the flight apparatus 100 moves the flight apparatus 100 to a position, at which another subject belonging to the another subject group does not overlap with at least one subject belonging to the target subject group or a single subject, or a position, at which another plural subjects belonging to the another subject group do not overlap with the at least one subject belonging to the target subject group or the single subject as shown in FIG. 9, and makes the camera 102 and the camera system 202 perform the image pickup operation at the position.

The operation of the controller 201 in the fourth embodiment of the invention is specifically described with reference to a flow chart in FIG. 10. The controller 201 repeatedly judges whether the flight apparatus 100 has left the hand of the user or whether the flight apparatus 100 has been thrown by the user (step S1001 in FIG. 10) similarly to the process at step S401 in FIG. 4 in the first embodiment of the invention.

When it is determined that the flight apparatus 100 has left the hand of the user or the flight apparatus 100 has been thrown by the user (YES at step S1001), the controller 201 controls the motor drivers (#1 to #4) 205 to drive the motors (#1 to #4) 104 and rotor blades 103 to make the flight apparatus 100 fly through the air to detect the target subject group as shown in FIG. 9 (step S1002).

More specifically, similarly to the process at step S602 in FIG. 6 in the second embodiment, the controller 201, for example, performs the face recognition process on image data obtained by the camera 102 and the camera system 202 to recognize the faces of the plural subjects. Then, the controller 201 detects the target subject group. A built-in receiver of the controller 201 receives a signal sent from a smart phone used by the at least one subject belonging to the subject group to detect the target subject group. Further, similarly to the first embodiment, once having confirmed a state in which the subject group remains still, the controller 201, for example, repeatedly performs the face recognition process on the image data to continuously capture the faces of the plural subjects of the target subject group.

When the flight apparatus 100 flies through the air to detect the target subject group (step S1002), the controller 201 judges whether the target subject group has been detected satisfactorily (step S1003).

When it is determined that the target subject group has not been detected (NO at step S1003), the controller 201 returns to the process of step S1002 and tries to detect the target subject group, again.

When it is determined that the target subject group has been detected (YES at step S1003), the controller 201 controls the motor drivers (#1 to #4) 205 to drive the motors (#1 to #4) 104 and rotor blades 103, thereby making the flight apparatus 100 hover at the current position. Then, the controller 201 performs the face recognition process on the image data output from the camera system 202 to detect the another subject not belonging to the target subject group or the another plural subjects not belonging to the target subject group (step S1004).

The controller 201 judges whether the another subject not belonging to the target subject group or the another plural subjects not belonging to the target subject group detected at step 1004 overlaps the target subject group detected at steps S1002 and 1003 or the single subject, or whether the target subject group detected at steps S1002 and 1003 or the single subject overlaps the another subject not belonging to the target subject group or the another plural subjects not belonging to the target subject group detected at step 1004 (step S1005).

When it is determined YES at step 1005, similarly to the process at step S606 in FIG. 6 in the second embodiment, while keeping capturing the target subject group, the controller 201 controls the motor drivers (#1 to #4) 205 to drive the motors (#1 to #4) 104 and rotor blades 103, thereby making the flight apparatus 100 fly through the air, for example, for a fixed distance in a random direction (step S1006).

Thereafter, the controller 201 returns to the process of step S1004, and detects the another subject not belonging to the target subject group or the another plural subjects not belonging to the target subject group, again, and then performs the overlapping judgment of step S1005, again.

When it is determined that the subject groups or the subjects do not overlap each other (NO at step S1005), similarly to the process at step S406 in FIG. 4 in the first embodiment of the invention, the controller 201 instructs the camera system 202 to make the camera 102 image the target subject group from the current position (step S1007). Then, the controller finishes the image pickup operation controlling process in the fourth embodiment of the invention.

With availability of the autonomous control of the flight apparatus 100 based on the operation of the controller in the fourth embodiment of the invention described above, simply throwing the flight apparatus 100 in the air, the user can make the camera 102 of the flight apparatus 100 image the plural subjects belonging to the line of the target subject group or the single subject without being overlapped by the another subject not belonging to the target subject group or the another plural subjects not belonging to the target subject group in a simple manner.

### Fifth Embodiment of the Invention

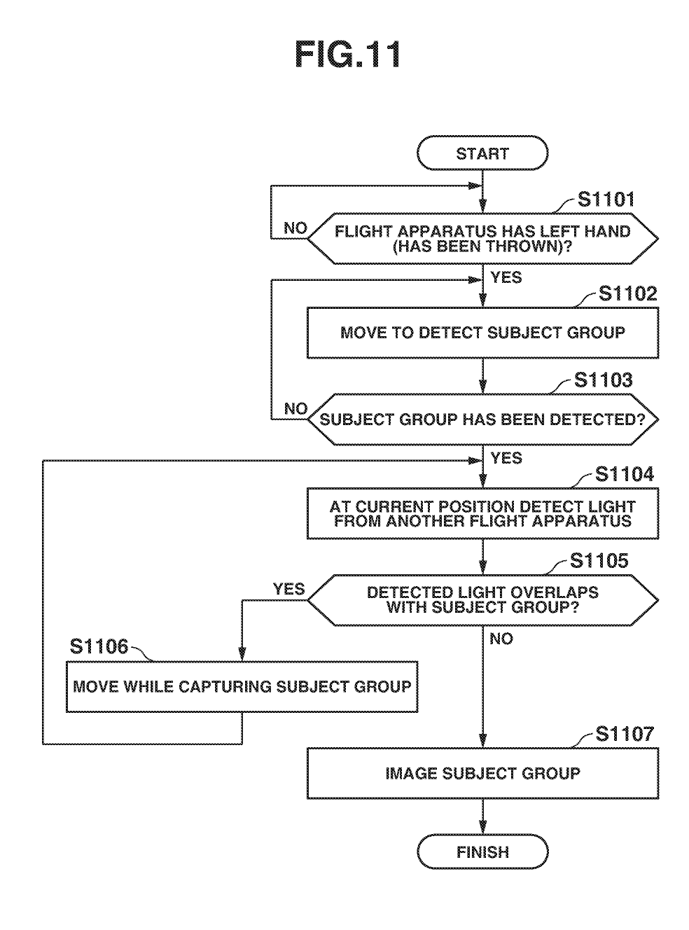

FIG. 11 is a flow chart of the imaging controlling operation process performed by the flight apparatus 100 according to a fifth embodiment of the invention. For instance when the image pickup operation is performed in the night, it is possible to confirm a position of the flight apparatus 100 of a drone-type by making a light source of the flight apparatus 100 flash, whereby the user can determine to which direction the flight apparatus 100 should be turned. In this case, when the flight apparatus 100 of the drone-type image the plural subjects or the single subject in the night while another drone-type flight apparatus is flashing light, the flight apparatus 100 is moved to a position, at which the light of the another drone-type flight apparatus does not overlap with the plural subjects or the single subject, and the camera 102 and the camera system 202 are made to perform the image pickup operation at the position.

The operation of the controller 201 in the fifth embodiment of the invention is specifically described with reference to the flow chart in FIG. 11. The controller 201 repeatedly judges whether the flight apparatus 100 has left the hand of the user or whether the flight apparatus 100 has been thrown by the user (step S1101 in FIG. 11), similarly to the process at step S401 in FIG. 6 in the first embodiment of the invention.

When it is determined that the flight apparatus 100 has left the hand of the user or the flight apparatus 100 has been thrown by the user (YES at step S1101), the controller 201 controls the motor drivers (#1 to #4) 205 to drive the motors (#1 to #4) 104 and rotor blades 103, thereby making the flight apparatus 100 fly through the air to detect the plural subjects or the single subject as shown in FIG. 10 (step S1102).

More specifically, similarly to the process at step S602 in FIG. 6 in the second embodiment, the controller 201, for example, performs the face recognition process on image data obtained by the camera 102 and the camera system 202, thereby recognizing faces of the plural subjects or a face of the single subject. Then, the controller 201 detects the plural subjects or the single subject. Similar to the process at step S1002 in FIG. 10 in the fourth embodiment, the built-in receiver of the controller 201 receives the signal sent from the smart phone used by the at least one subject belonging to the plural subjects or the signal sent from the smart phone used by the single subject to detect the plural subjects or the single subject. Further, similar to the first embodiment, once having confirmed a state in which the plural subjects or the single subject remains still, the controller 201, for example, repeatedly performs the face recognition process on the image data to continuously capture the faces of the plural subjects in the subject group or the face of the single subject.

When the flight apparatus 100 flies through the air to detect the plural subjects or the single subject (step S1102), the controller 201 judges whether the plural subjects or the single subject has been detected satisfactorily (step S1103).

When it is determined that the plural subjects or the single subject has not been detected (NO at step S1103), the controller 201 returns to the process of step S1102 and tries to detect the plural subjects or the single subject, again.

When it is determined that the plural subjects or the single subject has been detected (YES at step S1103), the controller 201 controls the motor drivers (#1 to #4) 205 to drive the motors (#1 to #4) 104 and rotor blades 103, thereby making the flight apparatus 100 hover at the current position. Then, the controller 201 detects the light emitted from another flight apparatus, while hovering at the current position (step S1104). More particularly, the controller 201 detects a light temporally moving in the air as the light to be detected.

The controller 201 judges whether the light detected at step S1104 overlaps with the plural subjects or the single subject detected at steps S1102 and S1103 (step S1105).

When it is determined that the light overlaps with the plural subjects or the single subject (YES at step S1105), similar to the process at step S606 in FIG. 6 in the second embodiment, while keeping capturing the plural subjects or the single subject, the controller 201 controls the motor drivers (#1 to #4) 205 to drive the motors (#1 to #4) 104 and rotor blades 103, thereby making the flight apparatus 100 fly through the air, for example, for a fixed distance in a random direction (step S1106).

Thereafter, the controller 201 returns to the process of step S1104, and detects the light and judges at step S1105 whether the light overlaps with the plural subjects or the single subject, again.

When it is determined that the light does not overlap with the plural subjects or the single subject (NO at step S1105), similarly to the process at step S406 in FIG. 4 in the first embodiment of the invention, the controller 201 instructs the camera system 202 to make the camera 102 image the plural subjects or the single subject from the current position (step S1107). Then, the controller finishes the image pickup operation controlling process in the fifth embodiment of the invention.

With availability of the autonomous control of the flight apparatus 100 based on the operation of the controller 201 in the fifth embodiment of the invention described above, simply throwing the flight apparatus 100 in the air, the user can make the camera 102 of the flight apparatus 100 image the plural subjects belonging to the line of the subject group or the single subject in a simple manner while avoiding an influence of the light of the another flight apparatus.

### Sixth Embodiment of the Invention

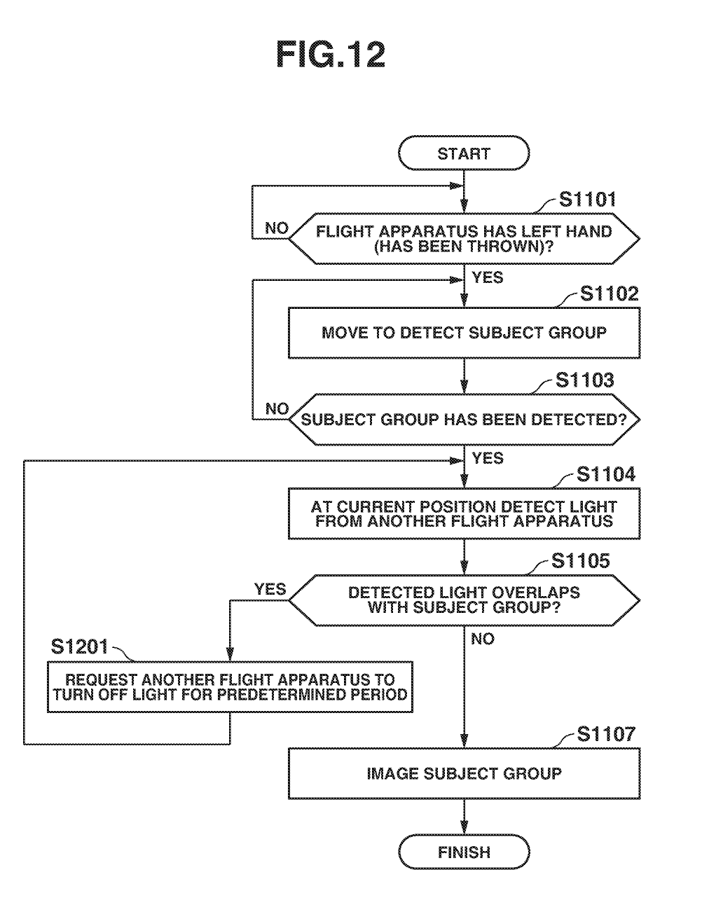

FIG. 12 is a flow chart of the imaging controlling operation process performed by the flight apparatus 100 according to a sixth embodiment of the invention. In the sixth embodiment, the imaging controlling operation process is performed by the flight apparatus 100 of a drone-type, when the imaging operation is performed to image a subject group or a single subject in the night, similar to the imaging operation in the fifth embodiment, while another drone-type flight apparatus is flashing light.

In the sixth embodiment of the invention, when the another drone-type flight apparatus is flashing the light, the flight apparatus 100 sends a request to the another flight apparatus, asking to stop flashing light for a predetermined period, and instructs the camera 102 and the camera system 202 to perform the image pickup operation.

In the flow chart of FIG. 12 in the sixth embodiment, the controller 201 performs the same processes (S1101 to S1107) as those given the same step numbers as the processes in the flow chart of FIG. 11.

The process at step S1201 in the flow chart of FIG. 12 in the sixth embodiment is different from the processes in the flow chart of FIG. 11 in the fifth embodiment. At the process of step S1201, the controller 201 sends a request to the another flight apparatus to turn off the light temporarily in place of moving away, when it has been determined that the light overlaps with the plural subjects or the single subject (step S1105).

As a result, having confirmed that the another flight apparatus has turned off the light and the light does not overlap with the plural subjects or the single subject (NO at step S1105), the controller 201 instructs the camera 102 and the camera system 202 to perform the image pickup operation.

With availability of the autonomous control of the flight apparatus 100 based on the operation of the controller in the fifth embodiment of the invention described above, simply throwing the flight apparatus 100 in the air, the user can make the camera 102 of the flight apparatus 100 image the plural subjects belonging to the line of the subject group or the single subject while avoiding an influence of the light of the another flight apparatus.

In the respective embodiments of the invention, the plural subjects or the single subject can be imaged in a simple manner as described above.

### Modifications

In the above description, the invention has been described taking as an example the flight apparatus of the drone type, having the propulsion unit for flying through the air, but the invention is not restricted to the flight apparatus. The present invention, for example, can be applied to a robot having a propulsion member for proceeding on the ground.

Further, in the above respective embodiments of the invention, the simple face recognizing process is applied and performed on the image data to capture the plural subjects belonging to the subject group or the single subject but it is possible to recognize smiling faces to capture the plural subjects belonging to the subject group or the single subject.

In the above described embodiments of the invention, it is possible for the user to use a switch to select the process to be performed.

In the above described embodiments of the invention, the flight apparatus 100 is allowed to perform the imaging operation, thereby obtaining any number of still images. The flight apparatus 100 can obtain not only still images but also moving images of an arbitrary time.

In the above described embodiments of the invention, the flight apparatus 100 has the propulsion unit including the motors 104 and rotor blades 103. But a propulsion unit using compressed air and/or an engine can be used in place of the propulsion unit including the motors 104 and rotor blades 103.

In the above described embodiments of the invention, a relationship between the plural subjects and the operator of the imaging apparatus 100 or a relationship between the single subject and the operator of the imaging apparatus 100 has not been explained. It is possible that the operator is included in the plural subjects or the operator is the single subject.

In the above described embodiments of the invention, the controlling unit controls the propulsion unit to move the flight apparatus such that the at least two out of the plural subjects and the image pickup unit do not interfere in position with each other, or such that the single subject and the image pickup unit do not interfere in position with each other, thereby allowing the image pickup unit to image the plural subjects or the single subject. But an image pickup timing is not restricted to the previously described timing.

Although specific embodiments of the invention have been described in the foregoing detailed description, it will be understood that the invention is not limited to the particular embodiments described herein, but modifications and rearrangements may be made to the disclosed embodiments while remaining within the scope of the invention as defined by the following claims. It is intended to include all such modifications and rearrangements in the following claims and their equivalents.

What is claimed is:

1. An image pickup apparatus comprising:
a propulsion unit which is used for propulsion of the image pickup apparatus;
an image pickup unit which images plural subjects or a single subject; and
a controlling unit which controls the propulsion unit to move the image pickup apparatus such that at least two out of the plural subjects and the image pickup unit do not interfere in position with each other, or such that the single subject and the image pickup unit do not interfere in position with each other, and instructs the image pickup unit to image the plural subjects or the single subject.

2. The image pickup apparatus according to claim 1, wherein
the controlling unit detects a line of the plural subjects, and controls the propulsion unit to move the image pickup apparatus to a position in a direction perpendicular to a longitudinal direction of the detected line of the plural subjects.

3. The image pickup apparatus according to claim 1, wherein
the controlling unit controls the propulsion unit to move the image pickup apparatus to a position, at which a shadow of the image pickup apparatus does not overlap with at least one of the plural subjects, or a position, at which the shadow of the image pickup apparatus does not overlap with the single subject.

4. The image pickup apparatus according to claim 1, wherein
the controlling unit controls the propulsion unit to move the image pickup apparatus to a position which a back light imaging of at least one of the plural subjects is not allowed, or a position, at which a back light imaging of the single subject is not allowed.

5. The image pickup apparatus according to claim 1, wherein
the controlling unit controls the propulsion unit to move the image pickup apparatus to a position, at which another subject of the plural subjects does not overlap with a face of at least one of the plural subjects.

6. The image pickup apparatus according to claim 1, wherein
the controlling unit controls the propulsion unit to move the image pickup apparatus to a position, at which another subject not belonging to the plural subjects does not overlap with at least one of the plural subjects or the single subject, or a position, at which another plural subjects not belonging to the plural subjects do not overlap with the at least one of the plural subjects or the single subject.

7. The image pickup apparatus according to claim 1, wherein
the controlling unit controls the propulsion unit to move the image pickup apparatus to a position, at which light of another image pickup apparatus does not overlap with at least one of the plural subjects, or a position, at which the light of the another image pickup apparatus does not overlap with the single subject.

8. The image pickup apparatus according to claim 1, wherein
when light of another image pickup apparatus overlaps with at least one of the plural subjects, or when the light of the another image pickup apparatus overlaps with the single subject, the controlling unit communicates with the another image pickup apparatus to ask for turning off the light of the another image pickup apparatus for a predetermined period.

9. The image pickup apparatus according to claim 1, wherein
when the controlling unit confirms that the plural subjects remain still, the controlling unit instructs the image pickup unit to image the plural subjects or the single subject.

10. The image pickup apparatus according to claim 1, wherein
the controlling unit comprises a recognition unit which recognizes and registers the plural subjects or the single subject, and
the controlling unit controls the propulsion unit to move the image pickup apparatus in accordance with a recognition result recognized by the recognition unit, while capturing the plural subjects or the single subject.

11. The image pickup apparatus according to claim 10, wherein
the recognition unit is a face recognizing unit which recognizes and registers a face of each of the plural subjects or a face of the single subject.

12. The image pickup apparatus according to claim 1, further comprising:
a receiving unit which receives a signal sent from at least one of the plural subjects or a signal sent from the single subject, and wherein
the controlling unit controls the propulsion unit depending on the signal received by the receiving unit to move the image pickup apparatus unit, while capturing the plural subjects or the single subject.

13. The image pickup apparatus according to claim 1, wherein
an operator of the image pickup apparatus is included in the plural subjects or the operator is the single subject.

14. The image pickup apparatus according to claim 1, wherein
the propulsion unit makes the image pickup apparatus fly in the air.

15. An image pickup method in an image pickup apparatus, the image pickup apparatus being provided with a controlling unit, a propulsion unit, and an image pickup unit for imaging plural subjects or a single subject, the image pickup method comprising steps of:
making the controlling unit control the propulsion unit to move the image pickup apparatus such that at least two out of the plural subjects and the image pickup unit do not interfere in position with each other, or such that the single subject and the image pickup unit do not interfere in position with each other; and
making the controlling unit instruct the image pickup unit to image the plural subjects or the single subject.

16. The image pickup method in the image pickup apparatus according to claim 15, wherein
the propulsion unit makes the image pickup apparatus fly in the air.

17. A non-transitory computer-readable recording medium with a computer program stored thereon, the computer program prepared for making a computer control an image pickup apparatus, wherein the image pickup apparatus is provided with a propulsion unit for propulsion of the image pickup apparatus and an image pickup unit for imaging plural subjects or a single subject, and the computer program, when installed on the computer,
making the computer control the propulsion unit to move the image pickup apparatus such that at least two out of the plural subjects and the image pickup unit do not interfere in position with each other, or such that the single subject and the image pickup unit do not interfere in position with each other; and
making the computer instruct the image pickup unit to image the plural subjects or the single subject.

18. The non-transitory computer-readable recording medium with the computer program stored thereon, according to claim 17, wherein
the computer program, when installed on the computer, making the computer control the propulsion unit to drive the image pickup apparatus to fly in the air.
